(19) United States
(12) Patent Application Publication
(10) Pub. No.: US 2026/0276850 A1
(43) Pub. Date: Sep. 17, 2026

(54) MULTI-PHASE FREE-FIELD INVERSION METHOD FOR NEAR-FAULT SITE BASED ON SPHERICAL/CYLINDRICAL DIFFUSION PROPERTIES

(71) Applicant: DALIAN UNIVERSITY OF TECHNOLOGY, Dalian (CN)

(72) Inventors: Zhiqian DONG, Dalian (CN); Yaohui XUE, Dalian (CN); Gang LI, Dalian (CN); Dinghao YU, Dalian (CN); Hongnan LI, Dalian (CN); Xin BAO, Dalian (CN)

(21) Appl. No.: 19/391,355

(22) Filed: Nov. 17, 2025

(30) Foreign Application Priority Data
May 21, 2025 (CN) 202510657934.0

(51) Int. Cl. G01V 1/28; G01V 1/30

(52) U.S. Cl. CPC G01V 1/282; G01V 1/284; G01V 1/303; G01V 1/306; G01V 1/308; G01V 2210/6222; G01V 2210/63; G01V 2210/65

(57) ABSTRACT

A multi-phase free-field inversion method for near-fault sites based on spherical/cylindrical diffusion properties. A dynamic stiffness matrix method is used to construct a multi-phase free-field inversion framework for near-fault sites, and then transforms an inversion problem into a multi-objective optimization problem for solving an “epicentral distance” and a “hypocenter depth”. The spatial-temporal difference between free-field displacement waveforms is quantified by a dynamic WPD, and objective functions are constructed according to the criterion of minimizing the differences between three-dimensional displacement waveforms at two adjacent points. At the same time, constraint conditions are set in combination with propagation and attenuation characteristics of seismic waves, thereby establishing a multi-objective optimization model for near-fault inversion. Subsequently, a NSGA-II is introduced to find a Pareto optimal solution of optimization variables, and the optimal solution is substituted into the inversion framework to complete the multi-phase free-field inversion for near-fault sites.

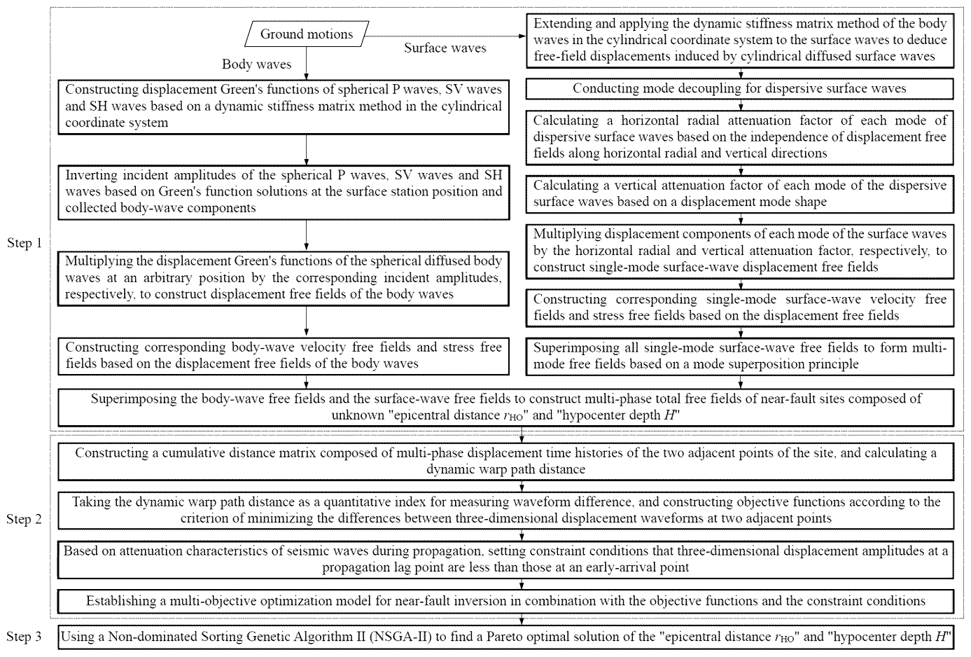

### TECHNICAL FIELD

The present invention relates to the field of seismic wavefield inversion, and relates to a multi-phase free-field inversion method for near-fault sites based on spherical/cylindrical diffusion properties.

### BACKGROUND

China is one of the countries with the highest seismic risk in the world, characterized by a high probability of moderate-to-large earthquakes and wide-ranging disaster impacts. The seismic performance of major infrastructures, such as tunnels, subways, utility tunnels, gravity dams and nuclear power plants, serving as primary carriers of earthquake hazards, directly impacts the safety of people's lives and property, as well as the healthy development of the economy and society. When subjected to earthquake loads, these structures exhibit non-negligible dynamic interactions with surrounding soils, known as the soil-structure interaction (SSI) systems. Seismic response analysis considering the SSI effect is a prerequisite for accurately assessing the seismic risk of infrastructures, and the process relies on the reasonable seismic input method and precise seismic excitation. Within the framework of existing boundary-equivalent load input methods, the unknown underground free fields serve as the excitation source for seismic input to SSI systems and need to be inverted using known ground motions and site conditions. The accuracy of the inverted underground free fields will directly affect the rationality of subsequent seismic input for structures and the reliability of response assessment, thereby affecting the safety of the structural design.

In existing free-field inversion methods, the assumption of plane waves is adopted whether the waves are body waves propagating obliquely or surface waves propagating horizontally, that is, the directions of wave lines remain consistent, and the wavefronts perpendicular to wave lines are planes. However, the assumption of plane waves only applies to a far-fault zone that is far from the epicenter. In the near-fault zone, body waves and surface waves exhibit true spherical and cylindrical diffusion properties, respectively. Specifically, body waves generated by fault dislocations will diffuse in the form of spherical waves from the hypocenter location to all directions, the directions of the wave lines are different, the wavefronts present spherical shapes, and energy attenuation is inversely proportional to the square of the propagation distance. Surface waves induced will diffuse in all directions in the form of cylindrical waves, the directions of the wave lines are also different, the wavefronts present cylindrical shapes, and energy attenuation is inversely proportional to the square root of the propagation distance. Particularly, the spherical waves and the cylindrical waves attenuate in all directions, and equipotential lines thereof are circles of the same spherical and cylindrical radii. In contrast, the energy of the plane waves only attenuates along the propagation direction thereof, and equipotential lines thereof are lines perpendicular to the propagation direction. The above difference in attenuation characteristics leads to different free-field responses in the near-fault and far-fault zones, thus making it difficult for far-fault free-field inversion methods based on the assumption of plane waves to reflect the free-field characteristics of the near-fault zone. More importantly, in the near-fault zone, special impulsive earthquakes will occur due to a directivity effect and a fling-step effect. Long-period components of the impulsive earthquakes are significant, and the energy carried thereby is mainly concentrated in a low-frequency band. Such a low-frequency characteristic makes a long-period structure in the near-fault zone prone to a “resonance effect” with the impulsive earthquakes, thereby intensifying the damage and fracture of the structure. The SSI system usually has a long natural vibration period, and existing far-fault inversion methods are difficult to accurately reflect the long-period pulse characteristics of the near-fault impulsive ground motions. Such limitation will directly affect the structural seismic response results. Therefore, it is urgently necessary to propose a free-field inversion method suitable for near-fault sites, so as to provide accurate excitation for seismic analysis of the SSI system in the near-fault zone, and thereby offer a reliable guidance for structural response assessment and seismic design.

### SUMMARY

The present invention provides a multi-phase free-field inversion method for near-fault sites based on spherical/cylindrical diffusion properties, which improves the research system in the field of near-fault inversion.

The present invention has the following technical solution:

Based on spherical diffusion properties of body waves and cylindrical diffusion properties of surface waves, the present invention uses a dynamic stiffness matrix method to construct a multi-phase free-field inversion framework for near-fault sites, and then transforms an inversion problem into a multi-objective optimization problem for solving an “epicentral distance” and a “hypocenter depth”. On this basis, the spatial-temporal difference between free-field displacement waveforms is quantified by a dynamic warp path distance (WPD), and objective functions are constructed according to the criterion of minimizing the differences between three-dimensional displacement waveforms at two adjacent points. At the same time, constraint conditions are set in combination with propagation and attenuation characteristics of seismic waves, thereby establishing a multi-objective optimization model for near-fault inversion. Subsequently, a Non-dominated Sorting Genetic Algorithm II (NSGA-II) is introduced to find a Pareto optimal solution of optimization variables, and the optimal solution is substituted into the inversion framework to complete the multi-phase free-field inversion for near-fault sites.

The multi-phase free-field inversion method for near-fault sites based on spherical/cylindrical diffusion properties comprises the following steps:

Step 1: establishing a multi-phase free-field inversion framework for near-fault layered-medium sites in a cylindrical coordinate system based on spherical diffusion properties of body waves and cylindrical diffusion properties of surface waves;

Step 2: taking unknown “epicentral distance r_{HO}” and “hypocenter depth H” in the multi-phase free-field inversion framework for near-fault layered-medium sites as optimization variables to transform an inversion problem into a multi-objective optimization problem; and constructing objective functions according to the criterion of minimizing the differences between three-dimensional displacement waveforms at two adjacent positions, and setting constraint conditions according to propagation and attenuation characteristics of seismic waves, thereby establishing a multi-objective optimization model for near-fault inversion; and

Step 3: using a Non-dominated Sorting Genetic Algorithm II (NSGA-II) to find a Pareto optimal solution of the optimization variables, and substituting the optimal solution into the inversion framework to complete multi-phase free-field inversion for near-fault sites.

Further, the process of step 1 is as follows:

Step 1.1: assuming a hypocenter is located in an underlying bedrock half-space, and establishing a cylindrical coordinate system r-θ-Z with the position of an epicenter as an origin, the direction of a line connecting the epicenter and a surface station as a radial direction, and the direction of the epicenter pointing to the hypocenter as a vertical direction;

Step 1.2: using a dynamic stiffness matrix method to calculate Green's functions of spherical diffusion P waves, SV waves and SH waves at an arbitrary position (r, θ, z) in the space, respectively:

$$\{ \begin{matrix}{\overline{U}}_{r}^{P , j} ( r , θ , z ) = {\int }_{0}^{∞} {\overline{u}}_{r}^{P , j} ( k , r , z ) k dk , {\overline{U}}_{Z}^{P , j} ( r , θ , z ) = {\int }_{0}^{∞} {\overline{u}}_{Z}^{P , j} ( k , r , z ) k d k \\ {\overline{U}}_{r}^{SV , j} ( r , θ , z ) = {\int }_{0}^{∞} {\overline{u}}_{r}^{SV , j} ( k , r , z ) k d k , {\overline{U}}_{Z}^{SV , j} ( r , θ , z ) = {\int }_{0}^{∞} {\overline{u}}_{Z}^{SV , j} ( k , r , z ) kdk \\ {\overline{U}}_{θ}^{S {H}_{j}} ( r , θ , z ) = {\int }_{0}^{∞} {\overline{u}}_{θ}^{SH , j} ( k , r , z ) k d k\end{matrix} \qquad ( 1 )$$

where k is a horizontal radial wavenumber;

$${\overline{u}}_{r}^{P , j} and {\overline{u}}_{Z}^{P , j}$$

are wavenumber-domain displacements of particles in the j^{th} layer of layered media induced by unit-amplitude P waves along radial and vertical directions, respectively;

$${\overline{u}}_{r}^{SV , j} and {\overline{u}}_{Z}^{SV , j}$$

are wavenumber-domain displacements of particles in the j^{th} layer of layered media induced by unit-amplitude SV waves along radial and vertical directions, respectively;

$${\overline{u}}_{θ}^{SH , j}$$

is a wavenumber-domain displacement of particles in the j^{th} layer of layered media induced by unit-amplitude SH waves along a circumferential direction; and

$${\overline{U}}_{r}^{P , j} , {\overline{U}}_{Z}^{P , j} , {\overline{U}}_{r}^{SV , j} , {\overline{U}}_{Z}^{SV , j} and {\overline{U}}_{θ}^{SH , j}$$

are spatial-domain displacement Green's functions obtained by Hankel inverse transformation of the above wavenumber-domain displacements, respectively;

Step 1.3: taking j=1 in formula (1) and calculating Green's function solutions of the three types of spherical diffusion body waves at a surface station position (r_{HO}, 0, 0):

$$\{ \begin{matrix}{\overline{U}}_{r}^{P , 1} ( r = {r}_{HO} , θ = 0 , z = 0 ) = {\int }_{0}^{∞} {\overline{u}}_{r}^{P , 1} ( k , {r}_{HO} , 0 ) kdk \\ {\overline{U}}_{Z}^{P , 1} ( r = {r}_{HO} , θ = 0 , z = 0 ) = {\int }_{0}^{∞} {\overline{u}}_{Z}^{P , 1} ( k , {r}_{HO} , 0 ) kdk\end{matrix} , P waves \qquad ( 2 )$$

$$\{ \begin{matrix}{\overline{U}}_{r}^{SV , 1} ( r = {r}_{HO} , θ = 0 , z = 0 ) = {\int }_{0}^{∞} {\overline{u}}_{θ}^{SV , 1} ( k , {r}_{HO} , 0 ) kdk \\ {\overline{U}}_{Z}^{SV , 1} ( r = {r}_{HO} , θ = 0 , z = 0 ) = {\int }_{0}^{∞} {\overline{u}}_{θ}^{SV , 1} ( k , {r}_{HO} , 0 ) kdk\end{matrix} , SV waves \qquad ( 3 )$$

$${\overline{U}}_{θ}^{SH , 1} ( r = {r}_{HO} , θ = 0 , z = 0 ) = {\int }_{0}^{∞} {\overline{u}}_{θ}^{SH , 1} ( k , {r}_{HO} , 0 ) kdk , SH waves \qquad ( 4 )$$

where the Green's function solutions depend on the unknown quantities “epicentral distance r_{HO}” and “hypocenter depth H”;

Step 1.4: using a normalized inner product (NIP) method to extract body-wave displacement components

$${U}_{ r}^{Body , 1} {U}_{θ}^{Body , 1} and {U}_{Z}^{Body , 1}$$

collected at the surface station, and inverting incident amplitudes

$${A}_{P}^{Body} , {A}_{SV}^{Body} and {A}_{SH}^{Body}$$

of the P waves, the SV waves and the SH waves based on formula (5):

$$( \begin{matrix}{A}_{P}^{Body} \\ {A}_{SV}^{Body} \\ {A}_{SH}^{Body}\end{matrix} ) = {[ \begin{matrix}{\overline{U}}_{r}^{P , 1} & {\overline{U}}_{r}^{SV , 1} & 0 \\ {\overline{U}}_{Z}^{P , 1} & {\overline{U}}_{Z}^{SV , 1} & 0 \\ 0 & 0 & {U}_{θ}^{SH , 1}\end{matrix} ]}^{- 1} ( \begin{matrix}{U}_{r}^{Body , 1} \\ {U}_{Z}^{Body , 1} \\ {U}_{θ}^{Body , 1}\end{matrix} ) \qquad ( 5 )$$

Step 1.5: multiplying the incident wave amplitudes obtained from formula (5) by the Green's functions shown in formula (1), respectively, to construct displacement free fields

$${U}_{r}^{Body , j} , {U}_{Z}^{Body , j} and {U}_{θ}^{Body , j}$$

induced by the spherical diffusion body waves at an arbitrary position in a spatial domain:

$$( \begin{matrix}{U}_{r}^{Body , j} \\ {U}_{Z}^{Body , j} \\ {U}_{θ}^{Body , j}\end{matrix} ) = {[ \begin{matrix}{\overline{U}}_{r}^{P , j} & {\overline{U}}_{r}^{SV , j} & 0 \\ {\overline{U}}_{Z}^{P , j} & {\overline{U}}_{Z}^{SV , j} & 0 \\ 0 & 0 & {U}_{θ}^{SH , j}\end{matrix} ] [ \begin{matrix}{\overline{U}}_{r}^{P , 1} & {\overline{U}}_{r}^{SV , 1} & 0 \\ {\overline{U}}_{Z}^{P , 1} & {\overline{U}}_{Z}^{SV , 1} & 0 \\ 0 & 0 & {U}_{θ}^{SH , 1}\end{matrix} ]}^{- 1} ( \begin{matrix}{U}_{r}^{Body , 1} \\ {U}_{Z}^{Body , J} \\ {U}_{θ}^{Body , 1}\end{matrix} ) \qquad ( 6 )$$

Step 1.6: performing time and space partial differential calculations on the body-wave displacement free fields, respectively, to construct corresponding velocity free fields and stress free fields and complete body-wave free-field inversion;

Step 1.7: extending and applying the dynamic stiffness matrix method for the body waves in the cylindrical coordinate system to surface waves to deduce spatial-domain free-field displacements

$${U}_{r}^{Ray , j} and {U}_{Z}^{Ray , j}$$

induced by cylindrical diffused Rayleigh waves:

$$\{ \begin{matrix}\begin{matrix}{U}_{r}^{Ray , j} ( r , θ , z ) = {U}_{X}^{Ray , j} ( z ) {\int }_{0}^{∞} [ {u}_{r}^{Ray , j} ( k , r ) ] kdk = \\ {U}_{X}^{Ray , j} ( z ) {\int }_{0}^{∞} \{ {\sum }_{α} \frac{\partial [ {J}_{α} ( k r ) ]}{\partial r} \} dk\end{matrix} \\ \begin{matrix}{U}_{Z}^{Ray , j} ( r , θ , z ) = {U}_{Z}^{Ray , j} ( z ) {\int }_{0}^{∞} [ {u}_{Z}^{Ray , j} ( k , r ) ] kdk = \\ {U}_{Z}^{Ray , j} ( z ) {\int }_{0}^{∞} [ - i {\sum }_{α} {J}_{α} ( k r ) ] kdk\end{matrix}\end{matrix} \qquad ( 7 )$$

$${U}_{X}^{Ray , j} ( z ) = {l}_{x}^{Ray , j} [ {A}_{P}^{Ray , j} exp ( ik {\tilde{s}}^{Ray , j} z ) + {B}_{P}^{Ray , j} exp ( - ik {\tilde{s}}^{Ray , j} z ) ] - {m}_{x}^{Ray , j} {\tilde{t}}^{Ray , j} [ {A}_{SV}^{Ray , j} exp ( - ik {\tilde{t}}^{Ray , j} z ) - {B}_{SV}^{Ray , j} exp ( - ik {\tilde{t}}^{Ray , j} z ) ] \qquad ( 8 )$$

$${U}_{Z}^{Ray , j} ( z ) = - {l}_{x}^{Ray , j} {\tilde{s}}^{Ray , j} [ {A}_{P}^{Ray , j} exp ( ik {\tilde{s}}^{Ray , j} z ) - {B}_{P}^{Ray , j} exp ( - ik {\tilde{s}}^{Ray , j} z ) ] - {m}_{x}^{Ray , j} [ {B}_{SV}^{Ray , j} exp ( ik {\tilde{t}}^{Ray , j} z ) + {B}_{SV}^{Ray , j} exp ( - ik {\tilde{t}}^{Ray , j} z ) ] \qquad ( 9 )$$

are wavenumber-domain displacements of particles in the j^{th} layer of layered media induced by the Rayleigh waves along radial and vertical directions of the cylindrical coordinate system, respectively;

$${U}_{X}^{Ray , j} and {U}_{Z}^{Ray , j}$$

are spatial-domain displacements induced by the Rayleigh waves in a plane coordinate system, respectively; i is an imaginary number symbol, satisfying i²=−1; Jₐ(kr) is an α-order Bessel function of the first kind;

$${A}_{p}^{Ray , j} and {B}_{p}^{Ray , j}$$

are amplitudes of upgoing and downgoing inhomogeneous P waves in the j^{th} layer of layered media, respectively;

$${A}_{SV}^{Ray , j} and {B}_{SV}^{Ray , j}$$

are amplitudes of upgoing and downgoing inhomogeneous SV waves in the j^{th} layer of layered media, respectively; k\tilde{s}^{Ray,j} and k\tilde{t}^{Ray,j} are vertical wavenumbers of the inhomogeneous P waves and the inhomogeneousSV waves, respectively;

$${l}_{x}^{Ray , j}$$

is the ratio of the P-wave velocity to the Rayleigh-wave velocity in the j^{th} layer of layered media, and

$${m}_{x}^{Ray , j}$$

is the ratio of the S-wave velocity to the Rayleigh-wave velocity in the j^{th} layer of layered media;
Step 1.8: similarly, deducing a free-field displacement

$${U}_{θ}^{Love , j}$$

induced by cylindrical diffused Love waves:

$${U}_{θ}^{Love , j} ( r , θ , z ) = {U}_{Y}^{Love , j} ( z ) {\int }_{0}^{∞} [ {u}_{θ}^{Love , j} ( k , r ) ] kdk = {U}_{Y}^{Love , j} ( z ) {\int }_{0}^{∞} \{ {\sum }_{α} \frac{\partial [ {J}_{α} ( kr ) ]}{\partial r} \} dk \qquad ( 10 )$$

$${U}_{Y}^{Love , j} ( z ) = {A}_{SH}^{Love , j} exp ( ik {\tilde{t}}^{Love , j} z ) + {B}_{SH}^{Love , j} exp ( - ik {\tilde{t}}^{Love , j} z ) \qquad ( 11 )$$

$$where {u}_{θ}^{Love , j}$$

is a wavenumber-domain displacement of particles in the j^{th} layer of layered media induced by the Love waves along a circumferential direction of the cylindrical coordinate system;

$${U}_{Y}^{Love , j}$$

is a spatial-domain displacement induced by Love waves in the plane coordinate system;

$${A}_{SH}^{Love , j} and {B}_{SH}^{Love , j}$$

are amplitudes of upgoing and downgoing inhomogeneous SH waves in the j^{th} layer of layered media, respectively; and k\tilde{t}^{Love,j} is a vertical wavenumber of inhomogeneous SH waves;
Step 1.9: conducting mode decoupling to dispersion surface waves, and deducing attenuation factors of single-mode surface-wave free-field displacements along a vertical direction by formula (12) based on displacement mode shapes:

$${R}_{r , m}^{Ray} ( z ) = \frac{{U}_{X , m}^{Ray , j} ( z )}{{U}_{X , m}^{Ray , 1} ( z = 0 )} , {R}_{Z , m}^{Ray} ( z ) = \frac{{U}_{Z , m}^{Ray , j} ( z )}{{U}_{Z , m}^{Ray , 1} ( z = 0 )} , \qquad ( 12 )$$

$${R}_{θ , m}^{Love} ( z ) = \frac{{U}_{Y , m}^{Love , j} ( z )}{{U}_{Y , m}^{Love , 1} ( z = 0 )}$$

where the subscript m represents the m^{th}-order mode of the dispersion surface waves;
Step 1.10: constructing single-mode surface-wave free fields at the surface station position (r_{HO}, 0, 0) and an arbitrary surface reference point (r, 0, 0) according to formulae (7)-(11); and further deducing attenuation factors of single-mode surface-wave free-field displacements along a horizontal radial direction by formula (13) based on the consistency criterion of vertical motions between two points:

$${R}_{r , m}^{Ray} ( r ) = \frac{{\int }_{0}^{∞} [ {u}_{r , m}^{Ray , 1} ( k , {r}_{HO} ) ] kdk}{{\int }_{0}^{∞} [ {u}_{r , m}^{Ray , 1} ( k , r ) ] kdk} , {R}_{Z , m}^{Ray} ( r ) = \frac{{\int }_{0}^{∞} [ {u}_{Z , m}^{Ray , 1} ( k , {r}_{HO} ) ] kdk}{{\int }_{0}^{∞} [ {u}_{Z , m}^{Ray , 1} ( k , r ) ] kdk} , \qquad ( 13 )$$

$${R}_{θ , m}^{Love} ( r ) = \frac{{\int }_{0}^{∞} [ {u}_{θ , m}^{Love , 1} ( k , {r}_{HO} ) ] kdk}{{\int }_{0}^{∞} [ {u}_{θ , m}^{Love , 1} ( k , r ) ] kdk}$$

Step 1.11: using the NIP method to extract surface-wave displacement components collected at the surface station, and multiplying decoupled single-mode displacements

$${U}_{r , m}^{Ray , 1} , {U}_{Z , m}^{Ray , 1} and {U}_{θ , m}^{Love , 1}$$

by the corresponding horizontal radial attenuation factors and vertical attenuation factors, respectively, to construct single-mode surface-wave displacement free fields at the arbitrary position (r, θ, z) in the spatial domain:

$$\{ \begin{matrix}{U}_{r , m}^{Ray , j} ( r , θ , z ) = {U}_{r , m}^{Ray , 1} ( {r}_{HO} , 0 , 0 ) {R}_{r , m}^{Ray} ( r ) {R}_{r , m}^{Ray} ( z ) \\ {U}_{Z , m}^{Ray , j} ( r , θ , z ) = {U}_{Z , m}^{Ray , 1} ( {r}_{HO} , 0 , 0 ) {R}_{Z , m}^{Ray} ( r ) {R}_{Z , m}^{Ray} ( z ) \\ {U}_{θ , m}^{Lowe , j} ( r , θ , z ) = {U}_{θ , m}^{Lowe , 1} ( {r}_{HO} , 0 , 0 ) {R}_{θ , m}^{Love} ( r ) {R}_{θ , m}^{Ray} ( z )\end{matrix} \qquad ( 14 )$$

where the single-mode surface-wave displacement free fields depend on the unknown quantity “epicentral distance r_{HO}”;
Step 1.12: performing time and space partial differential calculations on the single-mode surface-wave displacement free fields, respectively, to construct corresponding single-mode velocity and stress free fields;
Step 1.13: based on a mode superposition principle of surface waves, superimposing all single-mode free fields to form multi-mode free fields, thereby completing surface-wave free-field inversion; and
Step 1.14: superimposing the body-wave free fields and the surface-wave free fields to construct multi-phase total free fields of near-fault sites.

Further, the specific operation of the step 2 is as follows:
Step 2.1: taking the waveform difference at adjacent positions of the near-fault sites as an objective variable of the objective function, and using a dynamic warp path distance (WPD) as a quantitative index for measuring waveform difference with phase difference characteristics;
Step 2.2: constructing a cumulative distance matrix D composed of multi-phase displacement time histories

$${U}_{1}^{Total} ( t ) and {U}_{2}^{Total} ( t )$$

at two adjacent points of the near-fault sites:

$$D ( p , q ) = {d}_{pq} + min \{ \begin{matrix}D ( p - 1 , q ) \\ D ( p , q - 1 ) \\ D ( p - 1 , q - 1 )\end{matrix} ( p > , q > 1 ) \qquad ( 15 )$$

where p and q represent the row and column indices of the matrix, respectively, and D(p, q) is a matrix element at the position; d_{pq} is a Euclidean distance between the p^{th} discrete point in the displacement time history

$${U}_{1}^{Total} ( t )$$

and the q^{th} discrete point in the displacement time history

$${U}_{2}^{Total} ( t ) ;$$

Step 2.3: letting a warp path traverse the cumulative distance matrix D, starting from a top-left element position (1, 1) of the matrix and ending at the last element (n, n), and calculating a final cumulative distance along the warp path:

$$WPD 〈 {U}_{1}^{Total} , {U}_{2}^{Total} 〉 = D ( n , n ) \qquad ( 16 )$$

where n is the total number of discrete points in the two time histories; the smaller the value of WPD is, the shorter a traversal path is, and thus the smaller the difference between the displacement waveforms at the two adjacent points is;
Step 2.4: constructing objective functions according to the criterion of minimizing the differences between three-dimensional displacement waveforms at two adjacent points based on formula (17):

$${min}_{{r}_{HO} , H} f ( {r}_{HO} , H ) = \{ {f}_{1} ( {r}_{HO} , H ) , {f}_{2} ( {r}_{HO} , H ) , {f}_{3} ( {r}_{HO} , H ) \} \qquad ( 17 )$$

$$\{ \begin{matrix}{f}_{1} ( {r}_{HO} , H ) = WPD 〈 {U}_{1 , r}^{Total} , {U}_{2 , r}^{Total} 〉 \\ {f}_{2} ( {r}_{HO} , H ) = WPD 〈 {U}_{1 , θ}^{Total} , {U}_{2 , θ}^{Total} 〉 \\ {f}_{3} ( {r}_{HO} , H ) = WPD 〈 {U}_{1 , Z}^{Total} , {U}_{2 , Z}^{Total} 〉\end{matrix} , Δ r \geq 0$$

$$where {U}_{1 , r}^{Total} and {U}_{2 , r}^{Total}$$

are multi-phase displacements along the radial direction at the two adjacent points;

$${U}_{1 , θ}^{Total} and {U}_{2 , θ}^{Total}$$

are multi-phase displacements along the tangential direction; and

$${U}_{1 , Z}^{Total} and {U}_{2 , Z}^{Total}$$

are multi-phase displacements along the vertical direction;
Step 2.5: considering the attenuation characteristics of seismic waves during propagation, taking conditions that the three-dimensional displacement amplitudes

$$\vert {U}_{2}^{Total} {\vert}_{max}$$

at a propagation lag point are less than the corresponding displacement amplitudes

$$\vert {U}_{1}^{Total} {\vert}_{max}$$

at an early-arrival point as constraint conditions:

$$\{ \begin{matrix}{g}_{1} ( {r}_{H O} , H ) = \vert {U}_{2 , r}^{Total} {\vert}_{max} - \vert {U}_{1 , r}^{Total} {\vert}_{max} \leq 0 \\ {g}_{2} ( {r}_{H O} , H ) = \vert {U}_{2 , θ}^{Total} {\vert}_{max} - \vert {U}_{1 , θ}^{Total} {\vert}_{max} \leq 0 \\ {g}_{3} ( {r}_{H O} , H ) = \vert {U}_{2 , Z}^{Total} {\vert}_{max} - \vert {U}_{1 , Z}^{Total} {\vert}_{max} \leq 0\end{matrix} , Δr \geq 0 \qquad ( 18 )$$

Step 2.6: keeping the values of the two optimization variables greater than 0, and further narrowing down a feasible domain range:

$${r}_{H O} ∈ {R}^{+} , H ∈ {R}^{+} \qquad ( 19 )$$

Step 2.7: establishing a multi-objective optimization model for near-fault inversion in combination with the objective functions in formula (17) and the constraint conditions in formulae (18)-(19):

$${min}_{{r}_{H O} , H} f ( {r}_{H O} , H ) = \{ {f}_{1} ( {r}_{H O} , H ) , {f}_{2} ( {r}_{H O} , H ) , {f}_{3} ( {r}_{H O} , H ) \} \qquad ( 20 )$$

$$s . t . \{ \begin{matrix}{g}_{1} ( {r}_{H O} , H ) \leq 0 \\ {g}_{2} ( {r}_{H O} , H ) \leq 0 \\ {g}_{3} ( {r}_{H O} , H ) \leq 0 \\ {r}_{H O} ∈ {R}^{+} , H ∈ {R}^{+}\end{matrix} .$$

The present invention has the following beneficial effects:
(1) The present invention provides a multi-phase free-field inversion method for near-fault sites based on spherical/cylindrical diffusion properties, which gives full consideration to spherical diffusion properties of body waves and cylindrical diffusion properties of surface waves, makes up for the application limitation of the existing far-fault inversion methods for near-fault sites, and greatly improves the inversion accuracy. The results of comparative analysis show that the free-field results obtained by inversion are highly consistent with the real downhole records, so that the present invention provides more reliable seismic excitation for seismic response analysis of the SSI system, and has a significant engineering application value for revealing the real seismic response behavior, failure mechanism and failure mode of a structure.
(2) The method of the present invention can achieve precise inversion for key parameters of underground motions, reveal free-field characteristics of near-fault sites, and particularly accurately discriminate pulse characteristics and pulse periods of the underground motions.

Long-period pulse components in impulsive ground motions are the main cause of long-period structural damage in the near-fault zone. Particularly, when the pulse period is close to the natural vibration period of the structure, it is easy to induce a resonance effect. Therefore, discrimination of pulse characteristics and calculation of pulse periods are of great significance for the seismic design of long-period SSI systems. When the near-fault ground motions have pulse characteristics, the corresponding underground motion pulse characteristics and pulse periods thereof are both uncertain. Such uncertainty brings great challenges to seismic response assessment and seismic design of the SSI system in the near-fault zone. The method of the present invention can truly reflect the pulse characteristics of underground ground motions based on impulsive ground motions and local site conditions, thereby providing accurate excitation for seismic analysis of the SSI system and having a significant engineering application value. The results of formula derivation are reliable, and the calculation process is efficient.
(3) The method of the present invention transforms an overdetermined problem existing in the free-field inversion for the near-fault site into an optimization problem. By introducing a multi-objective optimization theoretical framework, the problem of solving an overdetermined equation system, which originally has no exact solution, is transformed into a parameter optimization problem with clear physical meaning, and an equilibrium solution of optimization variables under multi-objective control is obtained.

For the problem of that the overdetermined equation system has no exact solution, a least squares method is usually used in the field of mathematics to construct a constrained least squares problem, then the least squares problem is transformed into an optimization problem, and an optimal solution found to approximately replace the non-existent exact solution. Drawing on the experience of such a solution idea, the method of the present invention transforms the overdetermined problem of near-fault free field inversion into an optimization problem of finding an optimal solution of the “epicentral distance r_{HO}” and the “hypocenter depth H”. The idea has clear physical meaning, sufficient theoretical basis, and accurate and objective results, and provides a scientific analytical method for the study of near-fault seismic inversion.

### DESCRIPTION OF DRAWINGS

The sole figure is a flow chart of a method of the present invention.

### DETAILED DESCRIPTION

The present invention will be further described below in combination with the drawings in the embodiment of the present invention.

Step 1 in the sole figure is to construct an inversion framework of cylindrical diffused body-wave free fields and cylindrical diffused surface-wave free fields based on a dynamic stiffness matrix method in the cylindrical coordinate system, respectively, and superimposing the body-wave free fields and the surface-wave free fields to construct multi-phase total free fields of near-fault sites.

According to the theory of wave motions, the frequency-domain dynamic stiffness matrix of the site in the cylindrical coordinate system remains consistent with that in the plane coordinate system. Therefore, the frequency-domain dynamic stiffness matrix method based on the assumption of plane waves can be extended and applied to solve the free fields induced by cylindrical waves. In addition, the free fields induced by spherical waves can be transformed into the superposition of the free fields of the cylindrical waves in the frequency-wavenumber domain, thereby achieving the construction of the free fields of the spherical waves and the cylindrical waves, respectively. Based on the above principle, Ba et al. propose Green's function solutions for spherical P waves, SV waves and SH waves in three-dimensional layered media under the assumption of a point source, respectively. The overall idea is as follows: first, fixing a point source to obtain the in-layer solutions and fixed reaction forces; then reversely applying the fixed reaction forces to the adjacent layer of layered media to obtain the reaction force solutions; and finally, superimposing the in-layer solutions and the reaction force solutions to obtain the total Green's function solutions.

The method of the present invention draws on the experience of the idea to fix the hypocenter in the underlying bedrock half-space of layered media, and constructs the inversion framework of the body-wave free fields and the surface-wave free fields. In the underlying bedrock half-space, spatial domain potential functions of the spherical P waves, SV waves and SH waves induced by the hypocenter can be expanded by Hankel transformation into the integral superposition of cylindrical wave potential functions in the frequency-wavenumber domain:

$$( 21 )$$

$$\{ \begin{matrix}{φ}_{P}^{B o d y} ( R ) = \frac{{A}_{P}^{B o d y} exp ( - i {k}_{P} R )}{R} = {A}_{P}^{B o d y} {\int }_{0}^{∞} \frac{exp [ - i k ( {\tilde{s}}^{B o d y} ) \vert z \vert ]}{ik ( {\tilde{s}}^{B o d y} )} {J}_{0} ( k r ) k d k \\ {ψ}_{SV}^{B o d y} ( R ) = \frac{{A}_{SV}^{B o d y} exp ( - i {k}_{S} R )}{R} = {A}_{SV}^{B o d y} {\int }_{0}^{∞} \frac{exp [ - i k ( {\tilde{t}}^{B o d y} ) \vert z \vert ]}{ik ( {\tilde{t}}^{B o d y} )} {J}_{0} ( k r ) k d k \\ {χ}_{S H}^{B o d y} ( R ) = \frac{{A}_{S H}^{B o d y} exp ( - i {k}_{S} R )}{R} = {A}_{S H}^{B o d y} {\int }_{0}^{∞} \frac{exp [ - i k ( {\tilde{t}}^{B o d y} ) \vert z \vert ]}{i k ( {\tilde{t}}^{B o d y} )} {J}_{0} ( k r ) k d k\end{matrix}$$

$$where {φ}_{P}^{B o d y} , {ψ}_{SV}^{B o d y} and {χ}_{S H}^{B o d y}$$

are the potential functions of the spherical P waves, SV waves, and SH waves in the spatial domain, respectively;

$${A}_{P}^{B o d y} , {A}_{S V}^{B o d y} and {A}_{S H}^{B o d y}$$

are incident amplitudes of the three types of spherical body waves, respectively; k_{P} and k_{S} are wavenumbers of P waves and S waves, respectively, which are related to the complex compression wave velocity

$${V}_{P}^{*}$$

and the complex shear wave velocity

$${V}_{S}^{*}$$

of the half-space, satisfying

$${k}_{P} = ω / {V}_{P}^{*} and ks = ω / {V}_{S}^{*} ;$$

and R is seismic wave propagation distance, namely a distance connecting the propagation position and the hypocenter. When transformed from the spatial domain to the frequency-wavenumber domain, the seismic wave propagation distance R can be expressed as the square root of the sum of the squares of the horizontal radial propagation distance r and the vertical propagation distance z; k represents the horizontal radial wavenumber in the frequency-wavenumber domain; J₀(kr) is a 0-order Bessel function (the first kind); and

$$k {\tilde{s}}^{B o d y} and k {\tilde{t}}^{B o d y}$$

are vertical wavenumbers of the P waves and the S waves in the frequency-wavenumber domain, respectively, satisfying:

$${l}_{x}^{B o d y} = \frac{k {V}_{P}^{*}}{ω} , {m}_{x}^{B o d y} = \frac{k {V}_{s}^{*}}{ω} , {\tilde{s}}^{B o d y} = - i \sqrt{1 - \frac{1}{{( {l}_{x}^{B o d y} )}^{2}}} , {\tilde{t}}^{B o d y} = - i \sqrt{1 - \frac{1}{{( {m}_{x}^{B o d y} )}^{2}}} \qquad ( 22 )$$

According to formula (21), potential functions of cylindrical wave components of the spherical P waves, SV waves and SH waves under unit incident amplitude

$$( {A}_{P}^{B o d y} = {A}_{SV}^{B o d y} = {A}_{S H}^{B o d y} = 1 )$$

are respectively:

$${\overline{φ}}_{P}^{B o d y} ( k , r , z ) = \frac{k {e}^{- ik {\tilde{s}}^{Body} \vert z \vert}}{i {\tilde{s}}^{B o d y}} {J}_{0} ( k r ) , {\overline{ψ}}_{SV}^{B o d y} ( k , r , z ) = \frac{k {e}^{- ik {\tilde{t}}^{Body} \vert z \vert}}{i {\tilde{t}}^{B o d y}} {J}_{0} ( k r ) , {\overline{χ}}_{S H}^{B o d y} ( k , r , z ) = \frac{k {e}^{- ik {\tilde{t}}^{Body} \vert z \vert}}{i {\tilde{t}}^{B o d y}} {J}_{0} ( k r ) \qquad ( 23 )$$

Based on a displacement-potential function relationship in the cylindrical coordinate system, free-field displacements induced by unit-amplitude body waves in the bedrock half-space can be deduced as follows:

$$\{ \begin{matrix}{\overline{u}}_{r}^{Body} ( k , r , z ) = \frac{\partial [ {\overline{φ}}_{P}^{Body} ( k , r , z ) ]}{\partial r} + \frac{{\partial }^{2} [ {\overline{ψ}}_{S V}^{Body} ( k , r , z ) ]}{\partial r \partial z} \\ {\overline{u}}_{Z}^{Body} ( k , r , z ) = \frac{\partial [ {\overline{φ}}_{P}^{Body} ( k , r , z ) ]}{\partial z} - \\ \frac{{\partial }^{2} [ {\overline{ψ}}_{S V}^{Body} ( k , r , z ) ]}{\partial {r}^{2}} - \frac{\partial [ {\overline{ψ}}_{S V}^{Body} ( k , r , z ) ]}{r \partial r} \\ {\overline{u}}_{θ}^{Body} ( k , r , z ) = - \frac{\partial [ {\overline{χ}}_{S H}^{Body} ( k , r , z ) ]}{\partial r}\end{matrix} \qquad ( 24 )$$

$$where {\overline{u}}_{r}^{Body} , {\overline{u}}_{Z}^{Body} and {\overline{u}}_{θ}^{Body}$$

represent free-field displacement amplitudes of the unit-amplitude body waves along radial, vertical and circumferential directions in the frequency-wavenumber domain, respectively. It is worth noting that in the P-SV plane, the P waves and the SV waves are mutually coupled. Therefore, when calculating the free-field displacements induced by the P waves and the SV waves, respectively, the potential functions of the other side need to be set to 0. For example, when solving free-field displacements independently induced by the P waves, let

$${ψ}_{SV}^{B o d y} = 0 ;$$

on the contrary, when solving free-field displacements independently induced by the SV waves, let

$${φ}_{P}^{B o d y} = 0 .$$

Based on the free-field displacements obtained by the above formula, free-field stresses induced by the unit-amplitude body waves can be further calculated according to a stress-displacement relationship, as shown below:

$$\{ \begin{matrix}{\overline{τ}}_{r Z}^{Body} ( k , r , z ) = μ \{ \frac{\partial [ {\overline{u}}_{r}^{Body} ( k , r , z ) ]}{\partial z} + \frac{\partial [ {\overline{u}}_{Z}^{Body} ( k , r , z ) ]}{\partial r} \} \\ {\overline{σ}}_{Z Z}^{Body} ( k , r , z ) = λ \{ \frac{\partial [ {\overline{u}}_{r}^{Body} ( k , r , z ) ]}{\partial r} + \frac{{\overline{u}}_{r}^{Body} ( k , r , z )}{r} + \\ \frac{\partial [ {\overline{u}}_{Z}^{Body} ( k , r , z ) ]}{\partial z} \} + 2 μ \frac{\partial [ {\overline{u}}_{Z}^{Body} ( k , r , z ) ]}{\partial z} \\ {\overline{τ}}_{θ Z}^{B o d y} ( k , r , z ) = μ \frac{\partial [ {\overline{u}}_{θ}^{Body} ( k , r , z ) ]}{\partial z}\end{matrix} \qquad ( 25 )$$

where λ and μ are Lame constants of the underlying bedrock half-space. Particularly, when the distance from the top interface of the bedrock half-space to the hypocenter is d^{R}, the displacement amplitude and stress amplitude at the top interface of the half-space can be calculated by substituting z=−d^{R} into formulae (24)-(25). This part of solutions are special solutions and represented by a superscript “s”:

$$( 26 )$$

$$\{ \begin{matrix}\{ {\overline{u}}_{r}^{s} , {\overline{u}}_{Z}^{s} , {\overline{u}}_{θ}^{s} \} = {\overline{u}}_{r}^{Body} ( k , r , - {d}^{R} ) , {\overline{u}}_{Z}^{Body} ( k , r , - {d}^{R} ) , {\overline{u}}_{θ}^{Body} ( k , r , - {d}^{R} ) \} \\ \{ {\overline{τ}}_{rZ}^{s} , {\overline{σ}}_{ZZ}^{s} , {\overline{τ}}_{θ Z}^{s} \} = \{ {\overline{τ}}_{r Z}^{Body} ( k , r , - {d}^{R} ) , {\overline{σ}}_{Z Z}^{Body} ( k , r , - {d}^{R} ) , {\overline{τ}}_{θ Z}^{Body} ( k , r , - {d}^{R} ) \}\end{matrix}$$

At this moment, the amplitudes of external loads at the top interface of the half-space satisfies

$${\overline{F}}_{r}^{s} = - {\overline{τ}}_{rZ}^{s} ,$$

$${\overline{F}}_{Z}^{s} = - {\overline{σ}}_{ZZ}^{s} and {\overline{F}}_{θ}^{s} = - {\overline{τ}}_{θ Z}^{s} .$$

By substituting the special solutions of the displacement amplitude at the top interface of the half-space into a local dynamic balance equation of the half-space, homogeneous solutions (i.e., general solutions) of the amplitudes of the external loads at the top interface can be obtained, as shown in formulae (27) and (28). The homogeneous solutions are represented by a superscript “h”.

$$\{ \begin{matrix}{\overline{F}}_{r}^{h} \\ {\overline{F}}_{Z}^{h}\end{matrix} \} = - {[ {K}^{R} ]}_{P - S V} \{ \begin{matrix}{\overline{u}}_{r}^{s} \\ {\overline{u}}_{Z}^{s}\end{matrix} \} \qquad ( 27 )$$

$${\overline{F}}_{θ}^{h} = - {k}_{S H}^{R} {\overline{u}}_{θ}^{s} \qquad ( 28 )$$

where [K^{R}]_{P-SV} and

$${k}_{S H}^{R}$$

are a local dynamic stiffness matrix in the P-SV plane of the half-space and a local dynamic stiffness value out of the plane, respectively. By superimposing the special solutions and the homogeneous solutions of the amplitudes of the external loads at the top interface of the half-space, a total external load can be obtained:

$$\overline{{F}_{r}} = {\overline{{F}_{r}}}^{s} + {\overline{{F}_{r}}}^{h} , {\overline{F}}_{Z} = {\overline{F}}_{Z}^{s} + {\overline{F}}_{Z}^{h} , \overline{{F}_{θ}} = {\overline{{F}_{θ}}}^{s} + {\overline{{F}_{θ}}}^{h} \qquad ( 29 )$$

The top interface of the underlying bedrock half-space is also the bottom interface of the adjacent overlying soil layer medium. According to the criterion of inter-layer continuity, the external loads acting on the top interface of the half-space as shown in formula (29) will be reversely applied to the bottom interface of the adjacent overlying soil layer, thereby causing a dynamic response of particles in the overlying soil layers. Since the overlying soil layers contains no wave source, the external loads at the interface of each layer are zero. Thus, by integrating the amplitudes of the external loads at all interfaces of the layered media, external load amplitude vectors in the global cylindrical coordinate system are obtained:

$${\overline{F}}_{r - Z} = {\{ {\underbrace{0 , 0 , … 0 , 0 , , …}}_{2 N} , - {\overline{F}}_{r} , - {\overline{F}}_{Z} \}}^{T} ( in plane ) \qquad ( 30 )$$

$${\overline{F}}_{θ} = {\{ {\underbrace{0 , … 0 …}}_{N} , - {\overline{F}}_{θ} \}}^{T} ( out of plane ) \qquad ( 31 )$$

At this moment, the displacement amplitudes of all interfaces can be calculated based on global dynamic equilibrium equations, as shown below:

$${\overline{u}}_{r - Z} = {[ K ]}_{P - SV}^{- 1} {\overline{F}}_{r - Z} ( in plane ) \qquad ( 32 )$$

$${\overline{u}}_{θ} = {[ K ]}_{S H}^{- 1} {\overline{F}}_{θ} ( out of plane ) \qquad ( 33 )$$

where [K]_{P-SV} and [K]_{SH} are global dynamic stiffness matrices of in-plane and out-of-plane motions in the cylindrical coordinate system, respectively, which can be obtained by integrating the local dynamic stiffness matrices of the overlying N layers and the underlying bedrock half-space, and expressions thereof are exactly the same as those in the plane coordinate system. The global interface displacements obtained above are transformed into local displacements at the top and bottom interfaces of each layer of layered media; then the local dynamic equilibrium equation of each layer is used to calculate the upgoing and downgoing wave amplitudes within the layer; and further, by substituting the wave amplitudes and changing the coordinates, the free-field displacements at an arbitrary spatial position in the frequency-wavenumber domain can be obtained. Since this part of the free-field displacements are caused by the reaction force shown in formula (29), the solutions are named the reaction force solutions. The reaction force solutions of free-field displacements in the j^{th} layer induced by unit-amplitude P waves are expressed as

$${\overline{u}}_{r}^{p , j} and {\overline{u}}_{Z}^{p , j}$$

along radial and vertical directions, respectively; the reaction force solutions of free-field displacements in the j^{th} layer induced by unit-amplitude SV waves are expressed as

$${\overline{u}}_{r}^{SV , j} and {\overline{u}}_{Z}^{SV , j}$$

along radial and vertical directions, respectively; and the reaction force solutions of free-field displacements in the j^{th} layer induced by unit-amplitude SH waves are expressed as

$${\overline{u}}_{θ}^{SH , j}$$

along the circumferential direction. Based on displacement-velocity and displacement-stress relationships, corresponding reaction force solutions of free-field velocities and free-field stresses can be further deduced. Finally, the free fields in the frequency-wavenumber domain obtained above are transformed back into the spatial domain by Hankel inverse transformation, and thus the body-wave free fields in the spatial domain are obtained. For the underlying bedrock half-space, the free fields are composed of three parts: the special solutions, the homogeneous solutions, and the reaction force solutions. For the overlying layered soil layer, the free fields are composed only of reaction force solutions, and the displacement Green's functions thereof are shown in formula (1).

Based on the above displacement Green's functions, the body-wave free-field displacements at any arbitrary spatial location within the near-fault site can be obtained by multiplying these functions with the corresponding amplitudes, as shown in formula (6). Unknown amplitudes can be obtained by inversion through Green's function solutions at the surface station position shown in formulae (2)-(4) and displacement records collected at the point, as shown in formula (5). Finally, time and space partial differential calculations are performed on the body-wave free-field displacements, respectively, to construct body-wave velocity free fields and stress free fields and complete body-wave free-field inversion for the near-fault site.

The dynamic stiffness matrix method of the body waves in the cylindrical coordinate system is extended and applied to surface waves to deduce free-field displacements induced by cylindrical diffused Rayleigh/Love waves, as shown in formulae (7)-(11). Based on the independence of the horizontal radial and vertical motions in surface-wave free-field displacements, inversion can be performed in the two directions, respectively. In the vertical direction, the surface waves have multi-mode dispersion properties and are decoupled through the mode participation coefficients, and displacement mode shapes corresponding to each single mode are calculated. The ratio of the displacement amplitude at any arbitrary vertical position to that at the ground surface is characterized by the displacement mode shape. Therefore, the ratio of any elements in the mode vector to the first element can be defined as the vertical attenuation factor, as shown in formula (12). In the horizontal radial direction, the vertical motion consistency allows for establishing a displacement relationship between the surface station and an arbitrary reference point, and a horizontal radial attenuation factor can be defined on this basis, as shown in formula (13). Further, single-mode surface-wave displacement components collected at the surface station is multiplied by the horizontal radial attenuation factor and the vertical attenuation factor, respectively, to construct single-mode surface-wave displacement free fields at any arbitrary spatial position, as shown in formula (14). Time and space partial differential calculations are performed on the single-mode surface-wave displacement free-fields, respectively, to construct corresponding single-mode velocity free fields and stress free fields. Finally, based on the mode superposition principle, all single-mode surface-wave free fields are superimposed to form the multi-mode surface-wave free fields and complete surface-wave free-field inversion.

By superimposing the above body-wave free fields and surface-wave free fields, the multi-phase total free fields of near-fault sites are formed. However, in the process of body-wave free-field inversion, two unknown quantities, namely the “epicentral distance r_{HO}” and the “hypocenter depth H”, are used in calculating the Green's functions. The motion equilibrium equation system shown in formula (5) is used for solving the two unknown quantities. However, the number of equations (N_{f}=3) is greater than the number of the unknown quantities (Nₓ=2), which constitutes an overdetermined equation system in mathematics. In addition, in the process of surface-wave free-field inversion, it is also necessary to solve the unknown “epicentral distance r_{HO}”. In the motion equilibrium equation system shown in formula (14), the number of equations (N_{f}=3) is also greater than the number of the unknown quantities (Nₓ=1), which also constitutes an overdetermined equation system in mathematics. This means that the multi-phase free-field inversion for near-fault sites is essentially an overdetermined problem. At this moment, the unknown quantities “epicentral distance r_{HO}” and “hypocenter depth H” have no exact analytical solutions.

Step 2 in the sole figure is to transform the overdetermined problem in the inversion framework of step 1 into a multi-objective optimization problem, and establish a multi-objective optimization model by constructing reasonable objective functions and constraint conditions. The specific process is as follows:

For the problem where the overdetermined equation system has no exact solutions, a least squares method is usually used in the field of mathematics, recasting the problem as an optimization problem whose solution provides the best approximation. Following this concept, the method of the present invention transforms the overdetermined problem of near-fault free field inversion into an optimization problem of finding optimal solutions for optimization variables (the “epicentral distance r_{HO}” and the “hypocenter depth H”). In the optimization problem, the objective functions define the goal to be minimized, and the constraints ensure the feasibility of the solutions.

Under the framework of the near-fault free-field inversion, the objective functions are defined as minimizing the differences between multi-phase seismic records from any two adjacent site points, as predicted by the forward model using the selected optimization variable. Consequently, constructing the objective functions hinges on identifying a suitable objective variable to quantify the ground motion differences between these points. This variable should be a ground motion index that exhibits similar characteristics at both locations. In addition, the selected objective variable should also be highly sensitive to the two optimization variables. Based on the above criteria, the method of the present invention selects spectrum from the three elements (amplitude, spectrum and duration) characterizing the characteristics of ground motions as the objective variable. The spectrum is reflected as a waveform in the time domain. Thus, the objective functions can be constructed by minimizing the waveform differences between three-dimensional waveforms at the two points. However, conventional difference metrics such as root mean square error (RMSE) fail to adequately quantify similarity between waveforms exhibiting phase variations. On this basis, the method of the present invention uses a dynamic time warping (DTW) algorithm to define a warp path distance (WPD), which serves as an effective metric for quantifying waveform differences in the presence of phase variations.

The dynamic time warping algorithm is an effective method for measuring the difference between two time series, which have different time quantities and time shifts. The core of the algorithm is to align two time series by finding the optimal path, i.e., the shortest warping path that minimizes the sum of the total distances between all data points. is laid out by the non-overlapping elements of the cumulative distance matrix and quantified in terms of the warp path distance (WPD). Therefore, in the calculation process of WPD, a key step is to construct a bi-dimensional cumulative distance matrix D. According to the criterion of minimizing the difference between displacement waveforms at two adjacent points of the site, the displacement amplitudes of time discrete points in the time history

$${U}_{1}^{Total} ( t )$$

are arranged in sequence from left to right along the horizontal dimension, and the displacement amplitudes of time discrete points in the time history

$${U}_{2}^{Total} ( t )$$

are arranged in sequence from top to bottom along the vertical dimension. When the number of time discrete points of two displacement time histories is n, an n×n bi-dimensional matrix is formed. The values of various elements in the matrix represent the warp path distance between the corresponding displacement amplitudes at their specific positions. The DTW algorithm follows the continuity criterion and works starting from the first element (located in the upper left corner) of the matrix and traverses sequentially through the diagonal and adjacent elements. The continuity criterion requires that: any two adjacent points (p₁, q₁) and (p₂, q₂) in the path meet the condition of 0≤|p₁−p₂|≤1 or 0≤|q₁−q₂|≤1. Furthermore, the traversal process also adheres to the monotonicity criterion, that is, the two consecutive points (p₁, q₁) and (p₂, q₂) along the path satisfy p₂−p₁≥0 or q₂−q₁≥0. Finally, the warping path will end at a bottom-right element (n, n).

In the cumulative distance matrix D, the cumulative distance corresponding to the first element value D(1, 1) is equal to the Euclidean distance du between first discrete displacement points of the time histories

$${U}_{1}^{Total} ( t ) and {U}_{2}^{Total} ( t ) : \\ D ( 1 , 1 ) = {d}_{11} = \vert {U}_{1}^{Total} ( {t}_{1} ) - {U}_{2}^{Total} ( {t}_{1} ) \vert \qquad ( 34 )$$

Starting from position (1,1), the traversal path can move in one of three directions for the first step: horizontally to (2,1), vertically to (1,2), or diagonally to (2,2). The chosen direction is determined by selecting the minimum value among the D(2, 1), D(1, 2) and D(2, 2). The element value D(2, 1) represents a cumulative distance of the traversal path from the first element position to the second element position, which is composed of not only the Euclidean distance between

$${U}_{1}^{Total} ( {t}_{2} ) and {U}_{2}^{Total} ( {t}_{1} )$$

but also the summation with the previous traversal result D(1,1):

$$D ( 2 , 1 ) = {d}_{21} + D ( 1 , 1 ) = \vert {U}_{1}^{Total} ( {t}_{2} ) - {U}_{2}^{Total} ( {t}_{1} ) \vert + \vert {U}_{1}^{Total} ( {t}_{1} ) - {U}_{2}^{Total} ( {t}_{1} ) \vert \qquad ( 35 )$$

Similarly, the calculation of D(1, 2) is shown in formula (36):

$$D ( 1 , 2 ) = {d}_{12} + D ( 1 , 1 ) = \vert {U}_{1}^{Total} ( {t}_{1} ) - {U}_{2}^{Total} ( {t}_{2} ) \vert + \vert {U}_{1}^{Total} ( {t}_{1} ) - {U}_{2}^{T otal} ( {t}_{1} ) \vert \qquad ( 36 )$$

Without loss of generality, when the path traverses along the top or the left edge of the matrix, the cumulative distances to arbitrary element positions (p, 1) and (1, q) are:

$$\{ \begin{matrix}D ( p , 1 ) = {d}_{p 1} + D ( p - 1 , 1 ) \\ D ( 1 , q ) = {d}_{1 q} + D ( 1 , q - 1 )\end{matrix} \qquad ( 37 )$$

$$where$$

$$\{ \begin{matrix}{d}_{p 1} = \vert {U}_{1}^{Total} ( {t}_{p} ) - {U}_{2}^{Total} ( {t}_{1} ) \vert \\ {d}_{1 q} = \vert {U}_{1}^{Total} ( {t}_{1} ) - {U}_{2}^{Total} ( {t}_{q} ) \vert\end{matrix} \qquad ( 38 )$$

When the path traverses along element positions inside the matrix, the cumulative distance to an arbitrary element position (p, q) is shown in formula (15). Next, the traversal path will continue to move towards one of the matrix elements (p+1, q), (p, q+1) and (p+1, q+1) until reaching the end position (n, n). Correspondingly, an element value D(n, n) is the final cumulative distance along the warp path, that is, the warp path distance WPD between the two displacement time histories. As shown in formula (16), the smaller the value of WPD is, the shorter the traversal path is, and thus the smaller the difference between the displacement waveforms at the two adjacent points is; On this basis, multi-objective functions are established according to the criterion of minimizing the differences between three-dimensional displacement waveforms at two adjacent points, as shown in formula (17).

Constraint conditions impose restrictions on the domain of the optimization variables, usually in the form of equations or inequalities. Considering the attenuation characteristics during the propagation of body waves and surface waves, the method of the present invention takes the conditions that the three-dimensional displacement amplitudes at a propagation lag point are less than those at an early-arrival point as constraint conditions, thus inequality constraints shown in formula (18) are formed. In addition, the values of the two optimization variables should be greater than 0, as shown in formula (19). Finally, a multi-objective optimization model shown in formula (20) is formed in combination with the constraint conditions and the objective functions.

Step 3 in the sole figure is to use a Non-dominated Sorting Genetic Algorithm II (NSGA-II) to find a Pareto optimal solution of optimization variables (the “epicentral distance r_{HO}” and the “hypocenter depth H”), and substitute it into the inversion framework to complete multi-phase free-field inversion for near-fault sites. The principle is as follows:

In the multi-objective optimization problem, various objectives are usually restricted by each other, and significant negative correlation may exist between any two objectives. This means that in an optimization process, the improvement of one objective performance often comes at the cost of sacrificing other objective performances, and it is usually impossible to have a solution that optimizes all objective performances. Therefore, for the multi-objective optimization problem, the optimal solution is usually manifested as an equilibrium solution under multi-objective controls, and the solution is unmodifiable, that is, it is impossible to change an objective value of the solution without making other objectives worse. On this basis, the method of the present invention uses a Non-dominated Sorting Genetic Algorithm II (NSGA-II) based on emulation of biological evolution to obtain solutions. This classic algorithm for multi-objective optimization works by balancing trade-offs among objectives to identify equilibrium solutions, known as Pareto optimal solutions. The collection of all such solutions forms a set of non-dominated points called the Pareto front.

1. A multi-phase free-field inversion method for near-fault sites based on spherical/cylindrical diffusion properties, comprising the following steps:
step 1: establishing a multi-phase free-field inversion framework for near-fault layered-medium sites in a cylindrical coordinate system based on spherical diffusion properties of body waves and cylindrical diffusion properties of surface waves;
step 2: taking unknown “epicentral distance r_{HO}” and “hypocenter depth H” in the multi-phase free-field inversion framework for near-fault layered media as optimization variables to transform an inversion problem into a multi-objective optimization problem; and constructing objective functions according to the criterion of minimizing the differences between three-dimensional displacement waveforms at two adjacent positions, and setting constraint conditions according to propagation and attenuation characteristics of seismic waves, thereby establishing a multi-objective optimization model for near-fault inversion;
step 3: using a Non-dominated Sorting Genetic Algorithm II (NSGA-II) to find a Pareto optimal solution of the optimization variables, and substituting the optimal solution into the inversion framework to complete multi-phase free-field inversion for near-fault sites;
the process of step 1 is as follows:
step 1.1: assuming a hypocenter is located in an underlying bedrock half-space, and establishing a cylindrical coordinate system r-θ-Z with the position of an epicenter as an origin, the direction of a line connecting the epicenter and a surface station as a radial direction, and the direction of the epicenter pointing to the hypocenter as a vertical direction;
step 1.2: using a dynamic stiffness matrix method to calculate Green's functions of spherical diffusion P waves, SV waves and SH waves at an arbitrary position (r, θ, z) in the space, respectively:
$$\{ \begin{matrix}{\overline{U}}_{r}^{P , j} ( r , θ , z ) = {\int }_{0}^{∞} {\overline{u}}_{r}^{P , j} ( k , r , z ) kdk , & {\overline{U}}_{Z}^{P , j} ( r , θ , z ) = \\ & {\int }_{0}^{∞} {\overline{u}}_{Z}^{P , j} ( k , r , z ) kdk \\ {\overline{U}}_{r}^{SV , j} ( r , θ , z ) = {\int }_{0}^{∞} {\overline{u}}_{r}^{SV , j} ( k , r , z ) kdk , & {\overline{U}}_{Z}^{SV , j} ( r , θ , z ) = \\ & {\int }_{0}^{∞} {\overline{u}}_{Z}^{SV , j} ( k , r , z ) kdk \\ {\overline{U}}_{θ}^{SH , j} ( r , θ , z ) = {\int }_{0}^{∞} {\overline{u}}_{θ}^{SH , j} ( k , r , z ) kdk & \end{matrix} \qquad ( 1 )$$
where k is a horizontal radial wavenumber;
$${\overline{u}}_{r}^{P , j} and {\overline{u}}_{Z}^{P , j}$$
are wavenumber-domain displacements of particles in the j^{th} layer of layered media induced by unit-amplitude P waves along radial and vertical directions, respectively;
$${\overline{u}}_{r}^{SV , j} and {\overline{u}}_{Z}^{SV , j}$$
are wavenumber-domain displacements of particles in the j^{th} layer of layered media induced by unit-amplitude SV waves along radial and vertical directions, respectively;
$${\overline{u}}_{θ}^{SH , j}$$
is a wavenumber-domain displacement of particles in the j^{th} layer of layered media induced by unit-amplitude SH waves along a circumferential direction; and
$${\overline{U}}_{r}^{P , j} , {\overline{U}}_{Z}^{P , j} , {\overline{U}}_{r}^{SV , j} , {\overline{U}}_{Z}^{SV , j} and {\overline{U}}_{θ}^{SH , j}$$
are spatial-domain displacement Green's functions obtained by Hankel inverse transformation of the above wavenumber-domain displacements, respectively;
step 1.3: taking j=1 in formula (1) and calculating Green's function solutions of the three types of spherical diffusion body waves at a surface station position (r_{HO}, 0, 0):
$$\{ \begin{matrix}{\overline{U}}_{r}^{P , 1} ( r = {r}_{HO} , θ = 0 , z = 0 ) = {\int }_{0}^{∞} {\overline{u}}_{r}^{P , 1} ( k , {r}_{HO} , 0 ) kdk \\ {\overline{U}}_{Z}^{P , 1} ( r = {r}_{HO} , θ = 0 , z = 0 ) = {\int }_{0}^{∞} {\overline{u}}_{Z}^{P , 1} ( k , {r}_{HO} , 0 ) kdk\end{matrix} , P waves \qquad ( 2 )$$
$$\{ \begin{matrix}{\overline{U}}_{r}^{SV , 1} ( r = {r}_{HO} , θ = 0 , z = 0 ) = {\int }_{0}^{∞} {\overline{u}}_{r}^{SV , 1} ( k , {r}_{HO} , 0 ) kdk \\ {\overline{U}}_{Z}^{SV , 1} ( r = {r}_{HO} , θ = 0 , z = 0 ) = {\int }_{0}^{∞} {\overline{u}}_{Z}^{SV , 1} ( k , {r}_{HO} , 0 ) kdk\end{matrix} , SV waves \qquad ( 3 )$$
$${\overline{U}}_{θ}^{SH , 1} ( r = {r}_{HO} , θ = 0 , z = 0 ) = {\int }_{0}^{∞} {\overline{u}}_{θ}^{SH , 1} ( k , {r}_{HO} , 0 ) kdk , SH waves \qquad ( 4 )$$
where the Green's function solutions depend on the unknown quantities “epicentral distance r_{HO}” and “hypocenter depth H”;
step 1.4: using a normalized inner product (NIP) method to extract body-wave displacement components
$${U}_{r}^{Body , 1} , {U}_{θ}^{Body , 1} and {U}_{Z}^{Body , 1}$$
collected at the surface station, and inverting incident amplitudes
$${A}_{P}^{Body} , {A}_{SV}^{Body} and {A}_{SH}^{Body}$$
of the P waves, the SV waves and the SH waves based on formula (5):
$$( \begin{matrix}{A}_{P}^{Body} \\ {A}_{SV}^{Body} \\ {A}_{SH}^{Body}\end{matrix} ) = {[ \begin{matrix}{\overline{U}}_{r}^{P , 1} & {\overline{U}}_{r}^{SV , 1} & 0 \\ {\overline{U}}_{Z}^{P , 1} & {\overline{U}}_{Z}^{SV , 1} & 0 \\ 0 & 0 & {U}_{θ}^{SH , 1}\end{matrix} ]}^{- 1} ( \begin{matrix}{U}_{r}^{Body , 1} \\ {U}_{Z}^{Body , 1} \\ {U}_{θ}^{Body , 1}\end{matrix} ) \qquad ( 5 )$$
step 1.5: multiplying the incident wave amplitudes obtained from formula (5) by the Green's functions shown in formula (1), respectively, to construct displacement free fields
$${U}_{r}^{Body , j} , {U}_{Z}^{B ody , j} and {U}_{θ}^{B ody , j}$$
induced by the spherical diffusion body waves at an arbitrary position in a spatial domain:
$$( \begin{matrix}{U}_{r}^{Body , j} \\ {U}_{Z}^{Body , j} \\ {U}_{θ}^{Body , j}\end{matrix} ) = {[ \begin{matrix}{\overline{U}}_{r}^{P , j} & {\overline{U}}_{r}^{SV , j} & 0 \\ {\overline{U}}_{Z}^{P , j} & {\overline{U}}_{Z}^{SV , j} & 0 \\ 0 & 0 & {U}_{θ}^{SH , j}\end{matrix} ] [ \begin{matrix}{\overline{U}}_{r}^{P , 1} & {\overline{U}}_{r}^{SV , 1} & 0 \\ {\overline{U}}_{Z}^{P , 1} & {\overline{U}}_{Z}^{SV , 1} & 0 \\ 0 & 0 & {U}_{θ}^{SH , 1}\end{matrix} ]}^{- 1} ( \begin{matrix}{U}_{r}^{Body , 1} \\ {U}_{Z}^{Body , 1} \\ {U}_{θ}^{Body , 1}\end{matrix} ) \qquad ( 6 )$$
step 1.6: performing time and space partial differential calculations on the body-wave displacement free fields, respectively, to construct corresponding velocity free fields and stress free fields and complete body-wave free-field inversion;
step 1.7: extending and applying the dynamic stiffness matrix method for the body waves in the cylindrical coordinate system to surface waves to deduce spatial-domain free-field displacements
$${U}_{r}^{Ray , j} and {U}_{Z}^{Ray , j}$$
induced by cylindrical diffused Rayleigh waves:
$$\{ \begin{matrix}\begin{matrix}{U}_{r}^{Ray , j} ( r , θ , z ) = {U}_{X}^{Ray , j} ( z ) {\int }_{0}^{∞} [ {u}_{r}^{Ray , j} ( k , r ) ] kdk = \\ {U}_{X}^{Ray , j} ( z ) {\int }_{0}^{∞} \{ {\sum }_{α} \frac{\partial [ {J}_{α} ( k r ) ]}{\partial r} \} d k\end{matrix} \\ \begin{matrix}{U}_{Z}^{Ray , j} ( r , θ , z ) = {U}_{Z}^{Ray , j} ( z ) {\int }_{0}^{∞} [ {u}_{Z}^{Ray , j} ( k , r ) ] k dk = \\ {U}_{Z}^{Ray , j} ( z ) {\int }_{0}^{∞} [ - i {\sum }_{α} {J}_{α} ( k r ) ] k d k\end{matrix}\end{matrix} \qquad ( 7 )$$
$${U}_{X}^{Ray , j} ( z ) = {l}_{x}^{Ray , j} [ {A}_{P}^{Ray , j} exp ( ik {\tilde{s}}^{Ray , j} z ) + {B}_{P}^{Ray , j} exp ( - ik {\tilde{s}}^{Ray , j} z ) ] - {m}_{x}^{Ray , j} {\tilde{t}}^{Ray , j} [ {A}_{SV}^{Ray , j} exp ( ik {\tilde{t}}^{Ray , j} z ) - {B}_{SV}^{Ray , j} exp ( - ik {\tilde{t}}^{Ray , j} z ) ] \qquad ( 8 )$$
$${U}_{Z}^{Ray , j} ( z ) = - {l}_{x}^{Ray , j} {\tilde{s}}^{Ray , j} [ {A}_{P}^{Ray , j} exp ( ik {\tilde{s}}^{Ray , j} z ) - {B}_{P}^{Ray , j} exp ( - ik {\tilde{s}}^{Ray , j} z ) ] - {m}_{x}^{Ray , j} [ {A}_{SV}^{Ray , j} exp ( ik {\tilde{t}}^{Ray , j} z ) + {B}_{SV}^{Ray , j} exp ( - ik {\tilde{t}}^{Ray , j} z ) ] \qquad ( 9 )$$
$$where {u}_{r}^{Ray , j} and {u}_{z}^{Ray , j}$$
are wavenumber-domain displacements of particles in the j^{th} layer of layered media induced by the Rayleigh waves along radial and vertical directions of the cylindrical coordinate system, respectively;
$${U}_{X}^{Ray , j} and {U}_{Z}^{Ray , j}$$
are spatial-domain displacements induced by the Rayleigh waves in a plane coordinate system, respectively; i is an imaginary number symbol, satisfying i²=−1; J_{α}(kr) is an α-order Bessel function of the first kind;
$${A}_{P}^{Ray , j} and {B}_{P}^{Ray , j}$$
are amplitudes of upgoing and downgoing inhomogeneous P waves in the j^{th} layer of layered media, respectively;
$${A}_{SV}^{Ray , j} and {B}_{SV}^{Ray , j}$$
are amplitudes of upgoing and downgoing inhomogeneous SV waves in the j^{th} layer of layered media, respectively; k\tilde{s}^{Ray,j} and k\tilde{t}^{Ray,j} are vertical wavenumbers of the inhomogeneous P waves and the inhomogeneous SV waves, respectively;
$${l}_{x}^{Ray , j}$$
is the ratio of the P-wave velocity to the Rayleigh-wave velocity in the j^{th} layer of layered media; and
$${m}_{x}^{Ray , j}$$
is the ratio of the S-wave velocity to the Rayleigh-wave velocity in the j^{th} layer of layered media;
step 1.8: similarly, deducing a free-field displacement
$${U}_{θ}^{L ove , j}$$
induced by cylindrical diffused Love waves:
$${U}_{θ}^{Love , j} ( r , θ , z ) = {U}_{Y}^{Love , j} ( z ) {\int }_{0}^{∞} [ {u}_{θ}^{Love , j} ( k , r ) ] kdk = {U}_{Y}^{Love , j} ( z ) {\int }_{0}^{∞} \{ {\sum }_{α} \frac{\partial [ {J}_{α} ( k r ) ]}{\partial r} \} dk \qquad ( 10 )$$
$${U}_{Y}^{Love , j} ( z ) = {A}_{S H}^{Love , j} exp ( ik {\tilde{t}}^{Love , j} z ) + {B}_{S H}^{Love , j} exp ( - ik {\tilde{t}}^{Love , j} z ) \qquad ( 11 )$$
is a wavenumber-domain displacement of particles in the j^{th} layer of layered media induced by the Love waves along the circumferential direction of the cylindrical coordinate system;
$${U}_{Y}^{L ove , j}$$
is a spatial-domain displacement induced by Love waves in the plane coordinate system;
$${A}_{S H}^{L ove , j} and {B}_{S H}^{L ove , j}$$
are amplitudes of upgoing and downgoing inhomogeneous SH waves in the j^{th} layer of layered media, respectively; and k\tilde{t}^{Love,j} is a vertical wavenumber of the inhomogeneous SH waves;
step 1.9: conducting mode decoupling to dispersion surface waves, and deducing attenuation factors of single-mode surface-wave free-field displacements along a vertical direction by formula (12) based on mode shapes:
$${R}_{r , m}^{R a y} ( z ) = \frac{{U}_{X , m}^{Ray , j} ( z )}{{U}_{X , m}^{Ray , 1} ( z = 0 )} , {R}_{Z , m}^{R a y} ( z ) = \frac{{U}_{Z , m}^{Ray , j} ( z )}{{U}_{Z , m}^{Ray , 1} ( z = 0 )} , \qquad ( 12 )$$
$${R}_{θ , m}^{L o v e} ( z ) = \frac{{U}_{Y , m}^{Love , j} ( z )}{{U}_{Y , m}^{Love , 1} ( z = 0 )}$$
where the subscript m represents the m^{th}-order mode of the dispersion surface waves;
step 1.10: constructing single-mode surface-wave free fields at the surface station position (r_{HO}, 0, 0, and an arbitrary surface reference point (r, 0, 0) according to formulae (7)-(11); and further deducing attenuation factors of single-mode surface-wave free-field displacements along a horizontal radial direction by formula (13) based on the consistency criterion of vertical motions between two points:
$${R}_{r , m}^{R a y} ( r ) = \frac{{\int }_{0}^{∞} [ {u}_{r , m}^{Ray , 1} ( k , {r}_{HO} ) ] kdk}{{\int }_{0}^{∞} [ {u}_{r , m}^{Ray , 1} ( k , r ) ] kdk} , {R}_{Z , m}^{Ray} ( r ) = \frac{{\int }_{0}^{∞} [ {u}_{Z , m}^{Ray , 1} ( k , {r}_{HO} ) ] kdk}{{\int }_{0}^{∞} [ {u}_{Z , m}^{Ray , 1} ( k , r ) ] k d k} , \qquad ( 13 )$$
$${R}_{θ , m}^{L o v e} ( r ) = \frac{{\int }_{0}^{∞} [ {u}_{θ , m}^{L ove , 1} ( k , {r}_{HO} ) ] kdk}{{\int }_{0}^{∞} [ {u}_{θ , m}^{L ove , 1} ( k , r ) ] k d k}$$
step 1.11: using the NIP method to extract surface-wave displacement components collected at the surface station, and multiplying decoupled single-mode displacements
$${U}_{r , m}^{Ray , 1} , {U}_{Z , m}^{Ray , 1} and {U}_{θ , m}^{Love , 1}$$
by the corresponding horizontal radial attenuation factors and vertical attenuation factors, respectively, to construct single-mode surface-wave displacement free fields at the arbitrary position (r, θ, z) in the spatial domain:
$$\{ \begin{matrix}{U}_{r , m}^{Ray , j} ( r , θ , z ) = {U}_{r , m}^{Ray , 1} ( {r}_{HO} , 0 , 0 ) {R}_{r , m}^{Ray} ( r ) {R}_{r , m}^{Ray} ( z ) \\ {U}_{Z , m}^{Ray , j} ( r , θ , z ) = {U}_{Z , m}^{Ray , 1} ( {r}_{HO} , 0 , 0 ) {R}_{Z , m}^{Ray} ( r ) {R}_{Z , m}^{Ray} ( z ) \\ {U}_{θ , m}^{Lowe , j} ( r , θ , z ) = {U}_{θ , m}^{Lowe , 1} ( {r}_{HO} , 0 , 0 ) {R}_{θ , m}^{Love} ( r ) {R}_{θ , m}^{Love} ( z )\end{matrix} \qquad ( 14 )$$
where the single-mode surface-wave displacement free fields depend on the unknown quantity “epicentral distance r_{HO}”;
step 1.12: performing time and space partial differential calculations on the single-mode surface-wave displacement free fields, respectively, to construct corresponding single-mode velocity and stress free fields;
step 1.13: based on the mode superposition principle of surface waves, superimposing all single-mode free fields to form multi-mode free fields, thereby completing surface-wave free-field inversion; and
step 1.14: superimposing the body-wave free fields and the surface-wave free fields to construct multi-phase total free fields of near-fault sites.

2. The multi-phase free-field inversion method for near-fault sites based on spherical/cylindrical diffusion properties according to claim 1, wherein the specific operation of the step 2 is as follows:
step 2.1: taking the waveform difference at adjacent positions of the near-fault sites as an objective variable of the objective function, and using a dynamic warp path distance (WPD) as a waveform difference quantitative index for measuring phase difference characteristics;
step 2.2: constructing a cumulative distance matrix D composed of multi-phase displacement time histories
$${U}_{1}^{Total} ( t ) and {U}_{2}^{Total} ( t )$$
at two adjacent points of the near-fault sites:
$$D ( p , q ) = {d}_{pq} + min \{ \begin{matrix}D ( p - 1 , q ) \\ D ( p , q - 1 ) \\ D ( p - 1 , q - 1 )\end{matrix} ( p > 1 , q > 1 ) \qquad ( 15 )$$
where p and q represent the row and column indices of the matrix, respectively; D(p, q) is a matrix element at the position; d_{pq} is a Euclidean distance between the p^{th} discrete point in the displacement time history
$${U}_{1}^{Total} ( t )$$
and the q^{th} discrete point in the displacement time history
$${U}_{2}^{Total} ( t ) ;$$
step 2.3: letting a warp path traverse the cumulative distance matrix D, starting from a top-left element position (1, 1) of the matrix and ending at the last element (n, n), and calculating a final cumulative distance along the warp path:
$$WPD 〈 {U}_{1}^{Total} , {U}_{2}^{Total} 〉 = D ( n , n ) \qquad ( 16 )$$
where n is the total number of discrete points in the two time histories; the smaller the value of WPD is, the shorter a traversal path is, and thus the smaller the difference between the displacement waveforms at the two adjacent points is;
step 2.4: constructing objective functions according to the criterion of minimizing the differences between three-dimensional displacement waveforms at two adjacent points based on formula (17):
$${min}_{{r}_{HO} , H} f ( {r}_{HO} , H ) = \{ {f}_{1} ( {r}_{HO} , H ) , {f}_{2} ( {r}_{HO} , H ) , {f}_{3} ( {r}_{HO} , H ) \} \qquad ( 17 )$$
$$\{ \begin{matrix}{f}_{1} ( {r}_{HO} , H ) = WPD 〈 {U}_{1 , r}^{Total} , {U}_{2 , r}^{Total} 〉 \\ {f}_{2} ( {r}_{HO} , H ) = WPD 〈 {U}_{1 , θ}^{Total} , {U}_{2 , θ}^{Total} 〉 \\ {f}_{3} ( {r}_{HO} , H ) = WPD 〈 {U}_{1 , Z}^{Total} , {U}_{2 , Z}^{Total} 〉\end{matrix} , Δ r \geq 0$$
$$where {U}_{1 , r}^{Total} and {U}_{2 , r}^{Total}$$
are multi-phase displacements along the radial direction at the two adjacent points;
$${U}_{1 , θ}^{Total} and {U}_{2 , θ}^{Total}$$
are multi-phase displacements along the tangential direction; and
$${U}_{1 , Z}^{Total} and {U}_{2 , Z}^{Total}$$
are multi-phase displacements along the vertical direction;
step 2.5: considering the attenuation characteristics of seismic waves during propagation, taking conditions that the three-dimensional displacement amplitudes
$${\vert {U}_{2}^{Total} \vert}_{max}$$
at a propagation lag point are less than the corresponding displacement amplitudes
$${\vert {U}_{1}^{Total} \vert}_{max}$$
at an early-arrival point as constraint conditions:
$$\{ \begin{matrix}{g}_{1} ( {r}_{HO} , H ) = {\vert {U}_{2 , r}^{Total} \vert}_{max} - {\vert {U}_{1 , r}^{Total} \vert}_{max} \leq 0 \\ {g}_{2} ( {r}_{HO} , H ) = {\vert {U}_{2 , θ}^{Total} \vert}_{max} - {\vert {U}_{1 , θ}^{Total} \vert}_{max} \leq 0 \\ {g}_{3} ( {r}_{HO} , H ) = {\vert {U}_{2 , Z}^{Total} \vert}_{max} - {\vert {U}_{1 , Z}^{Total} \vert}_{max} \leq 0\end{matrix} , Δ r \geq 0 \qquad ( 18 )$$
step 2.6: keeping the values of the two optimization variables greater than 0, and further narrowing down a feasible domain range:
$${r}_{HO} ∈ {R}^{+} , H ∈ {R}^{+} \qquad ( 19 )$$
step 2.7: establishing a multi-objective optimization model for near-fault inversion in combination with the objective functions in formula (17) and the constraint conditions in formulae (18)-(19):
$${min}_{{r}_{HO} , H} f ( {r}_{HO} , H ) = \{ {f}_{1} ( {r}_{HO} , H ) , {f}_{2} ( {r}_{HO} , H ) , {f}_{3} ( {r}_{HO} , H ) \} \qquad ( 20 )$$
$$s . t . \{ \begin{matrix}{g}_{1} ( {r}_{HO} , H ) \leq 0 \\ {g}_{2} ( {r}_{HO} , H ) \leq 0 \\ {g}_{3} ( {r}_{HO} , H ) \leq 0 \\ {r}_{HO} ∈ {R}^{+} , H ∈ {R}^{+}\end{matrix} .$$
